(19) United States
(12) Patent Application Publication
(10) Pub. No.: US 2026/0065868 A1
(43) Pub. Date: Mar. 5, 2026

(54) DISPLAY DEVICE AND CONTROL METHOD

(71) Applicant: Japan Display Inc., Tokyo (JP)

(72) Inventors: Koichi OKUDA, Tokyo (JP); Shinichi KOMURA, Tokyo (JP); Jin HIROSAWA, Tokyo (JP)

(73) Assignee: Japan Display Inc., Tokyo (JP)

(21) Appl. No.: 19/298,315

(22) Filed: Aug. 13, 2025

(30) Foreign Application Priority Data
Sep. 3, 2024 (JP) 2024-151589

(51) Int. Cl. G09G 3/34; F21V 8/00; G02F 1/13357

(52) U.S. Cl. CPC G09G 3/3413; G09G 3/342; G02B 6/0068; G02F 1/133615; G02F 1/133621; G09G 2320/0233

(57) ABSTRACT

According to one embodiment, a display device includes a display panel, a light guide having a side surface, and a light source unit facing the side surface, and a controller. The light source unit includes a plurality of first light emitting elements arranged along the side surface to emit light of the same color. When a period from the time when the light source unit is turned on until the time when the light source unit is turned on again is referred to as one cycle, the controller controls a lighting time per one cycle of one first light emitting element which is located farther from a center of the side surface, of two adjacent first light emitting elements, to be shorter than a lighting time per one cycle of the other first light emitting element.

### CROSS-REFERENCE TO RELATED APPLICATIONS

This application is based upon and claims the benefit of priority from Japanese Patent Application No. 2024-151589, filed Sep. 3, 2024, the entire contents of which are incorporated herein by reference.

### FIELD

Embodiments described herein relate generally to a display device and a control method.

### BACKGROUND

For example, a display device such as a liquid crystal display device comprises a display panel with pixels and an illumination device such as a backlight which illuminates the display panel. The illumination device comprises a light source and a light guide which emits light from the light source. The light emitted from the light source is made incident on the light guide, propagates the inside of the light guide, and is emitted from an emission surface of the light guide.

### BRIEF DESCRIPTION OF THE DRAWINGS

FIG. 1 is an exploded perspective view showing a configuration example of a display device of an embodiment.

FIG. 2 is a block diagram showing the configuration example of the display device of the embodiment.

FIG. 3 is a schematic plan view showing an illumination device shown in FIG. 1.

FIG. 4 is a schematic cross-sectional view showing the display device shown in FIG. 1.

FIG. 5 is a schematic plan view showing a light guide and light source units shown in FIG. 3.

FIG. 6 is a timing chart showing an example of controlling a light emitting element by a controller.

FIG. 7 is a timing chart showing an example of controlling the light emitting elements by the controller.

FIG. 8 is a timing chart showing an example of controlling the light emitting elements by the controller.

### DETAILED DESCRIPTION

In general, according to one embodiment, a display device includes a display panel having a display area, a light guide having a side surface, and a main surface facing the display panel, and a light source unit facing the side surface and emitting light toward the light guide, and a controller controlling the light source unit. The light source unit includes a plurality of first light emitting elements arranged along the side surface to emit light of the same color. When a period from the time when the light source unit is turned on until the time when the light source unit is turned on again is referred to as one cycle, the controller controls a lighting time per one cycle of one first light emitting element which is located farther from a center of the side surface, of two adjacent first light emitting elements, to be shorter than a lighting time per one cycle of the other first light emitting element.

According to another embodiment, a display device controlling method includes, when a period from the time when the light source unit is turned on until the time when the light source unit is turned on again is referred to as one cycle, making a lighting time per one cycle of one light emitting element which is located farther from a center of the side surface, of two adjacent light emitting elements provided in the light source unit and emitting light of the same color, shorter than a lighting time per one cycle of the other light emitting element.

According to such a configuration, a display device and a control method capable of improving the display quality can be provided.

Embodiments will be described hereinafter with reference to the accompanying drawings. The disclosure is a mere example, and arbitrary change of gist which can be easily conceived by a person of ordinary skill in the art naturally falls within the inventive scope.

In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. As described herein, the third direction Z may be referred to as “above” or “on”, and a direction opposite to the third direction Z may be referred to as “below” or “under”.

In the present embodiment, a liquid crystal display device is disclosed as an example of the display device. However, the technical idea disclosed in the present embodiment can be applied to, as other display devices, for example, display devices comprising other types of display elements such as an organic electroluminescent display element, a micro-LED or a mini-LED. In addition, the technical idea disclosed in the present embodiment can also be applied to an array substrate or electronic device comprising a sensor element such as a capacitive sensor or an optical sensor.

For example, the display device of the present embodiment can be used for various devices such as a vehicle-mounted device, a smartphone, a tablet terminal, a mobile phone terminal, a personal computer, a television receiver, a game console, and a head-mounted display (for, for example, VR).

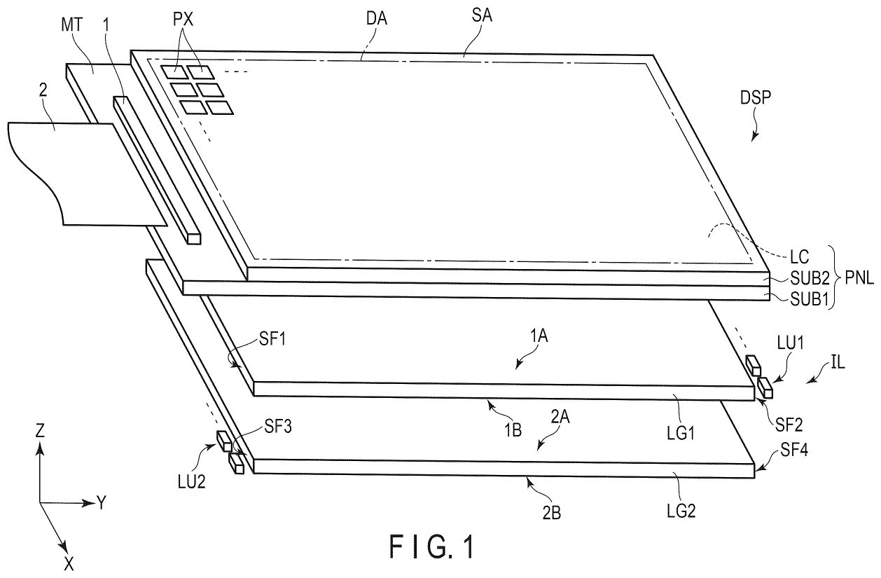

FIG. 1 is an exploded perspective view showing a configuration example of a display device DSP of the present embodiment. The display device DSP comprises a display panel PNL, an illumination device IL, an IC chip 1, and a wiring board 2.

The display panel PNL comprises a first substrate SUB1, a second substrate SUB2, and a liquid crystal layer LC. The first substrate SUB1 and the second substrate SUB2 face each other. The liquid crystal layer LC is provided between the first substrate SUB1 and the second substrate SUB2.

The display panel PNL has a display area DA where images are displayed and a frame-shaped surrounding area SA surrounding the display area DA. The display area DA is located substantially in the center of an area where the first substrate SUB1 and the second substrate SUB2 face each other. The display panel PNL includes a plurality of pixels PX arrayed in matrix in the first direction X and the second direction Y, in the display area DA.

In the example shown in FIG. 1, the first substrate SUB1 has a mounting area MT formed in a portion which protrudes in the direction opposite to the second direction Y relative to the second substrate SUB2. The mounting area MA is part of the surrounding area SA.

The IC chip 1 and the wiring board 2 are mounted on the mounting area MT. The IC chip 1 and the wiring board 2 mainly function as signal sources which supply control signals to the display panel PNL. The wiring board 2 is, for example, a flexible printed board which can be bent. Incidentally, the IC chip 1 may be provided on the wiring board 2.

The illumination device IL illuminates the display panel PNL. The illumination device IL comprises light guides LG1 and LG2, and light source units LU1 and LU2. The light guide LG2, the light guide LG1, the first substrate SUB1, and the second substrate SUB2 are stacked in this order in the third direction Z.

The light guides LG1 and LG2 are insulating substrates such as glass substrates or plastic substrates. Then light guide LG2 may be or may not be formed of the same material as the light guide LG1.

The light guides LG1 and LG2 are formed in a flat panel shape parallel to an X-Y plane defined by the first direction X and the second direction Y. The sizes of the light guides LG1 and LG2 are, for example, equal to each other.

The light guide LG1 has a main surface 1A facing the display panel PNL, a main surface 1B on a side opposite to the main surface 1A, and side surfaces SF1 and SF2 that connect the main surfaces 1A and 1B. The side surfaces SF1 and SF2 extend in the first direction X. The side surface SF1 faces in a direction opposite to the second direction Y, and the side surface SF2 faces in the second direction Y.

The light guide LG2 has a main surface 2A facing the main surface 1B, a main surface 2B on a side opposite to the main surface 2A, and side surfaces SF3 and SF4 that connect the main surfaces 2A and 2B. The main surface 2A faces the display panel PNL through the light guide LG1. The side surfaces SF3 and SF4 extend in the first direction X. The side surface SF3 faces in a direction opposite to the second direction Y, and the side surface SF4 faces in the second direction Y.

The light source units LU1 emit light toward the side surface SF2. In other words, the light emission direction of the light source units LU1 is opposite to the second direction Y. The light source units LU1 face the side surface SF2.

The light source units LU2 emit light toward the side surface SF3. In other words, the light emission direction of the light source units LU2 is the second direction Y. The light emission direction of light source units LU2 is opposite to the light emission direction of the light source units LU1. The light source units LU2 face the side surface SF3.

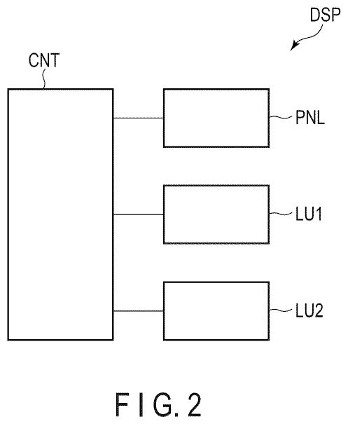

FIG. 2 is a block diagram showing a configuration example of the display device DSP of the present embodiment. The display device DSP further comprises a controller CNT. The controller CT controls each of the display panel PNL and the light source units LU1 and LU2. The controller CNT controls the display panel PNL via, for example, an IC chip 1 (shown in FIG. 1).

Furthermore, the controller CNT supplies light source control signals to the light source units LU1 and LU2 to control the light source units, synchronously with supplying the control signals to the display panel PNL. Images are thereby displayed in the display area DA. In this case, the images are, for example, letters or characters, photographs, illustrations, moving images, or the like.

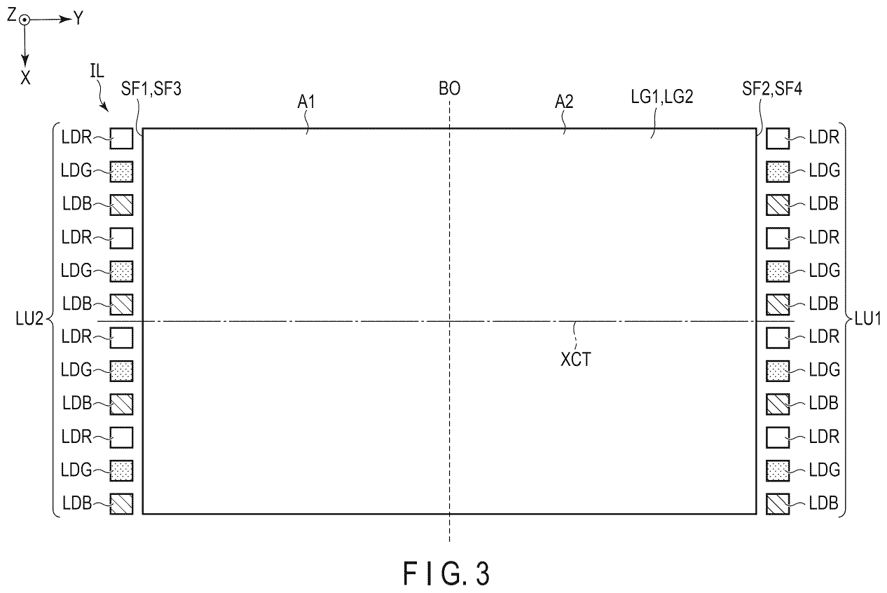

FIG. 3 is a schematic plan view showing the illumination device IL shown in FIG. 1. In FIG. 3, the illumination device IL is viewed in a direction opposite to the third direction Z. The light guides LG1 and LG2 have a rectangular shape elongated in the second direction Y.

The illumination device IL has a first area A1 and a second area A2. The first area A1 and the second area A2 are arranged in this order in the second direction Y. The side surfaces SF1 and SF3 are located in the first area A1, and the side surfaces SF2 and SF4 are located in the second area A2.

A boundary between the first area A1 and the second area A2 is defined as boundary BO, and a line passing through the center of the width in the first direction X of the light guides LG1 and LG2 is defined as center line XCT. In addition, an area including a part where the side surfaces SF2 and SF3 intersect with the center line XCT may be referred to as a center of the side surfaces SF2 and SF3. For example, the size of the first area A1 is equal to the size of the second area A2. In other words, the boundary BO passes through the center of the width in the second direction Y of the light guides LG1 and LG2.

Each of the light source units LU1 and LU2 includes a plurality of light emitting elements that emit light of different colors. The plurality of light emitting elements include a plurality of light emitting elements LDR that emit red light, a plurality of light emitting elements LDG that emit green light, and a plurality of light emitting elements LDB that emit blue light. In other words, the light emitting elements LDR, LDG, and LDB emit light of the same colors.

The light emitting elements LDR, LDG, and LDB are, for example, laser light sources (for example, laser diodes) that emit polarized laser light. As described herein, the light emitting element LDR is an example of the first light emitting element, the light emitting element LDG is an example of the third light emitting element, and the light emitting element LDB is an example of the second light emitting element.

For example, the light emitting elements LDR, LDG, and LDB are arranged repeatedly in this order at intervals in the first direction X. In other words, the light emitting elements LDR, LDG, and LDB are arranged in this order along the side surfaces SF2 and SF3. The intervals are, for example, regular intervals, but are not limited to this example.

The light source units LU1 and LU2 can obtain light of mixed colors (for example, white) by, for example, adjusting the light emitted from the light emitting elements LDR, LDG, and LDB by additive color mixing. Incidentally, the light source units LU1 and LU2 may further include light emitting elements that emit light of colors other than red, green, and blue.

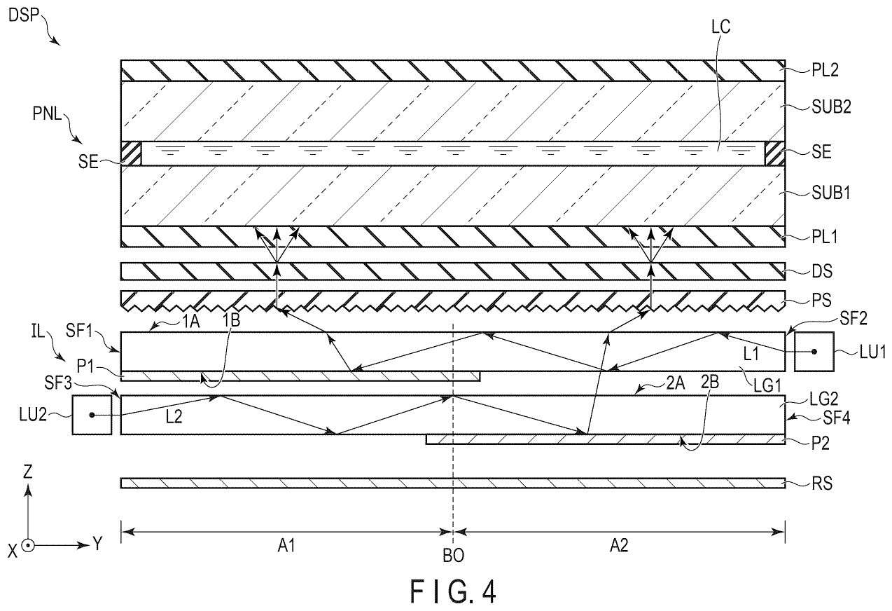

FIG. 4 is a schematic cross-sectional view showing the display device DSP shown in FIG. 1. The display panel PNL further comprises a seal SE and polarizers PL1 and PL2.

The seal SE is located between the first substrate SUB1 and the second substrate SUB2. The seal SE adheres the first substrate SUB1 and the second substrate SUB2. Furthermore, the seal SE seals the liquid crystal layer LC between the first substrate SUB1 and the second substrate SUB2.

The polarizer PL1 is attached to the lower surface of the first substrate SUB1. The polarizer PL2 is attached to the upper surface of the second substrate SUB2. The polarization axis of the polarizer PL1 and the polarization axis of the polarizer PL2 are, for example, orthogonal to each other.

The illumination device IL further comprises a diffusion sheet DS, a prism sheet PS, and a reflective sheet RS. The diffusion sheet DS is located between the display panel PNL and the light guide LG1. The diffusion sheet DS diffuses the light which is made incident on the diffusion sheet DS and uniformizes the luminance of the light.

The prism sheet PS is located between the diffusion sheet DS and the light guide LG1. For example, the prism sheet PS condenses the light emitted from the main surface 1A of the light guide LG1, in the third direction Z.

The prism sheet PS is composed of a plurality of prisms continuously arranged in the second direction Y. The plurality of prisms of the prism sheet PS protrude toward the main surface 1A of the light guide LG1 in the third direction Z.

The prisms of the prism sheet PS have a triangular cross-sectional shape parallel to the Y-Z plane defined by the second direction Y and the third direction Z. The cross-sectional shapes of each prism of the prism sheet PS, which are parallel to the Y-Z plane, are similar to each other. Incidentally, the plurality of (for example, two) prism sheets PS may be stacked in the third direction Z.

The reflective sheet RS faces the main surface 2B of the light guide LG2. For example, the reflective sheet RS reflects the light leaking from the light guide LG2 and makes the light incident on the light guide LG2 again.

The light guide LG1 includes a reflective layer P1, and the light guide LG2 includes a reflective layer P2. Each of the reflective layers P1 and P2 is a layer including a plurality of prisms. The reflective layer P1 is located on the main surface 1B. The reflective layer P1 is formed to extend from the first area A1 to an area between the boundary BO and the side surface SF2 beyond the boundary BO.

The reflective layer P2 is located on the main surface 2B. The reflective layer P2 is formed to extend from the second area A2 to an area between the boundary BO and the side surface SF3 beyond the boundary BO. The reflective layer P1 and the reflective layer P2 overlap in the third direction Z in the boundary BO and the vicinity of the boundary BO. The light source unit LU1 is spaced apart from the side surface SF2, and the light source unit LU2 is spaced apart from the side surface SF3.

Light L1 emitted from the light source unit LS1 is refracted on the side surface SF2 and is made incident on the light guide LG1. Light which travels toward the main surface 1A, of the light L1 made incident on the light guide LG1, is reflected on the interface between the light guide LG1 and an air layer.

In addition, light which travels toward the main surface 1B, of the light L1 made incident on the light guide LG1, is reflected on the interface between the light guide LG1 and an air layer. Thus, the light L1 travels inside the light guide LG1 while being repeatedly reflected, in the area where the reflective layer P1 is not provided in the second area A2.

The traveling direction of the light which travels from the light guide LG1 to the reflective layer P1, of the light L1 which travels inside the light guide LG1, is changed by the prisms of the reflective layer P1, and the light is emitted from the main surface 1A without satisfying the total reflection conditions of the main surface 1A.

The light emitted from the main surface 1A illuminates the display panel PNL via the prism sheet PS and the diffusion sheet DS. In other words, in the area in which the reflective layer P1 is not provided in the second area A2, the light L1 from the side surface SF2, which is emitted from the light guide LG1 to the display panel PNL, is suspended.

Similarly, light L2 emitted from the light source unit LU2 is refracted on the side surface SF3 and is made incident on the light guide LG2. The light L2 travels inside the light guide LG2 while being repeatedly reflected on the main surfaces 2A and 2B, in the area where the reflective layer P2 is not provided in the first area A1.

The traveling direction of the light which travels from the light guide LG2 to the reflective layer P2, of the light L2 which travels inside the light guide LG2, is changed by the prisms of the reflective layer P2, and the light is emitted from the main surface 2A without satisfying the total reflection conditions of the main surface 2A.

The light emitted from the main surface 2A illuminates the display panel PNL via the light guide LG1, the prism sheet PS, and the diffusion sheet DS. In other words, in the area where the reflective layer P2 is not provided in the first area A1, the light L2 from the side surface SF3, which is emitted from the light guide LG2 to the display panel PNL, is suspended.

Thus, the display panel PNL is mainly illuminated by the light L1 from the light source unit LU1 in the first area A1 and is mainly illuminated by the light L2 from the light source unit LU2 in the second area A2.

In the example shown in FIG. 4, the light L1 made incident from the side surface SF2 is confined within the light guide LG1 and its incidence on the display panel PNL is suppressed, in the area where the reflective layer P1 is not provided, in the second area A2. In the second area A2, the light L1 from the light source unit LU1 is hardly made incident on the display panel PNL, but the light L2 from the light source unit LU2 illuminates the display panel PNL.

Similarly, the light L2 made incident from the side surface SF3 is confined within the light guide LG2 and its incidence on the display panel PNL is suppressed, in the area where the reflective layer P2 is not provided, in the first area A1. In the first area A1, the light L2 from the light source unit LU2 is hardly made incident on the display panel PNL, but the light L1 from the light source unit LU1 illuminates the display panel PNL.

Furthermore, the reflective layer P1 extends to the second area A2 beyond the boundary BO, and the reflective layer P2 extends to the first area A1 beyond the boundary BO. For this reason, the situation in which the luminance level of the light emitted from the illumination device IL decreases in the vicinity of the boundary BO can be avoided.

Next, the control of the light emitting elements LDR, LDG, and LDB by the controller CNT using the light guide LG2 and the light source unit LU2 provided in the illumination device IL will be described.

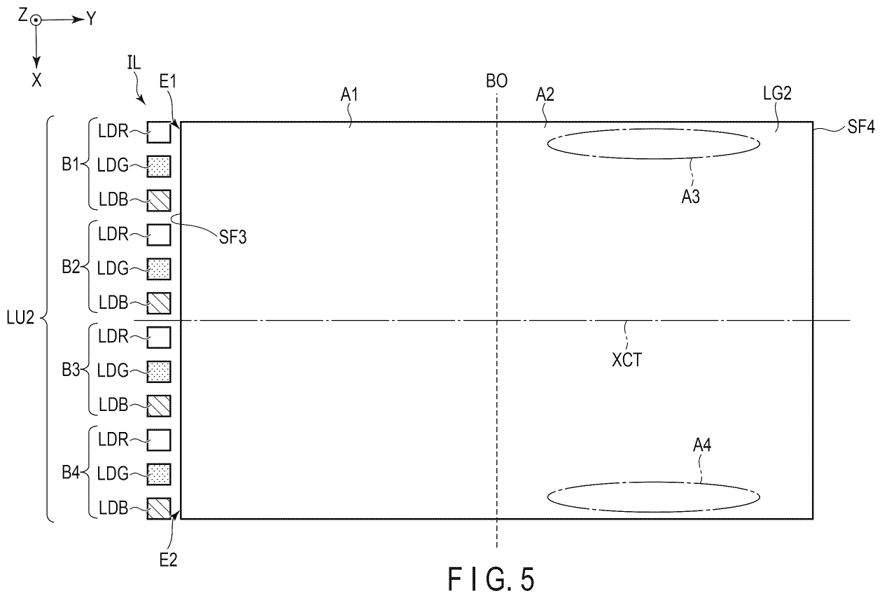

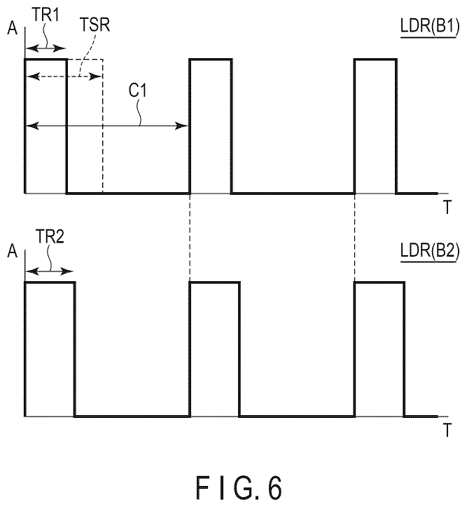

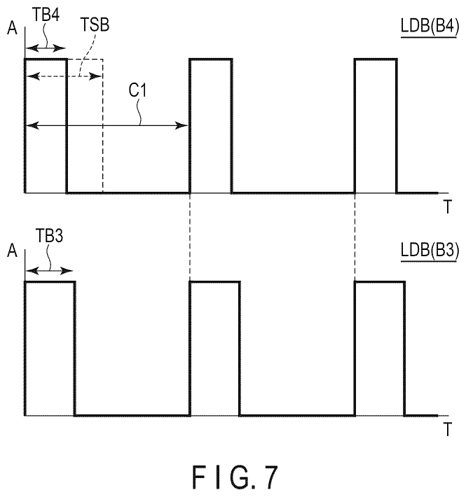

FIG. 5 is a schematic plan view showing the light guide LG2 and the light source unit LU2 shown in FIG. 3. FIG. 6 and FIG. 7 are timing charts showing an example of controlling the light emitting elements LDR and LDB by the controller CNT. In FIG. 6 and FIG. 7, the horizontal axis T indicates time, and the vertical axis A indicates the current value of the current supplied to the light emitting elements.

In the light source unit LU2, for example, one block is composed of the light emitting elements LDR, LDG, and LDB. The light source unit LU2 includes blocks B1, B2, B3, and B4.

The blocks B1, B2, B3, and B4 are arranged in this order in the first direction X, in the example shown in FIG. 5. Incidentally, the number of light emitting elements and blocks provided in the light source unit LU2 is appropriately changed depending on the size of display panel PNL and the light guide LG2.

The side surface SF3 has a first end portion E1 and a second end portion E2. The first end portion E1 and the second end portion E2 correspond to both end portions of the side surface SF3. The second end portion E2 is located on a side opposite to the first end portion E1 in the first direction X.

The end portion includes the edge and its surrounding area. The block B1 faces the first end portion E1, and the block B4 faces the second end portion E2. When the light emitting elements LDR, LDG, and LDB are arranged as shown in FIG. 5, the light emitting element LDR of the block B1 and the light emitting element LDG of the block B4 are located farthest from the center line XCT. In other words, the light emitting elements LDR and LDB are located at both ends of the light source unit LU2, while the light emitting element LDG is not located at either end of the light source unit LU2.

The controller CNT (shown in FIG. 2) is configured to individually control the lighting times of the plurality of light emitting elements LDR, LDG, and LDB. More specifically, the controller CNT controls the lighting time per cycle of the plurality of light emitting elements LDR, LDG, and LDB.

One cycle refers to the period from the time when the light emitting element is turned on until the time when the light emitting element is turned on again. In FIG. 6 and FIG. 7, one cycle is referred to as one cycle C1. The length of one cycle C1 for light emitting elements LDR, LDG, and LDB is, for example, the same. The light emitting elements LDR, LDG, and LDB repeatedly turn on and off in every cycle C1.

In addition, the lighting time (DUTY) per one cycle C1 may be referred to as a DUTY ratio. In other words, the controller CNT controls pulse widths of light source control signals supplied to the light emitting elements LDR, LDG, and LDB.

The light emitting elements LDR will be focused. For example, the controller CNT controls each lighting time per cycle C1, based on positions of the plurality of light emitting elements LDR in the first direction X. In other words, the controller CNT controls supplying the light source control signals of different pulse width to the plurality of light emitting elements LDR, respectively, based on the positions of the light emitting elements LDR in the first direction X.

For example, the blocks B1 and B2 will be focused. The light emitting element LDR in the block B1 and the light emitting element LDR in the block B2 are adjacent to each other in the first direction X, as shown in FIG. 5. The light emitting element LDR in the block B1 is located farther from the center line XCT (the center of the side surface SF3) than the light emitting element LDR in the block B2. Incidentally, the light emitting elements LDG and LDB in the block B1 are located between the light emitting element LDR in the block B1 and the light emitting elements LDR in the block B2.

In this case, the controller CNT controls the lighting time per one cycle C1 of the light emitting element LDR in the block B1 to be shorter than the lighting time per one cycle C1 in the light emitting element LDR of the block B2.

In FIG. 6, the lighting times per cycle C1 of the light emitting elements LDR in the blocks B1 and B2 are represented as time TR1 and time TR2. As described above, in FIG. 6, the time TR1 is shorter than the time TR2 (TR1<TR2).

Among the light emitting elements LDR, the light emitting element LDR in the block B3 is the closest to the center line XCT. The lighting time per cycle C1 of the light emitting element LDR in the block B3 is assumed to be 100%.

In this case, for example, the controller CNT controls the lighting time per cycle C1 of the light emitting element LDR in the block B1 to be 59.7% of the lighting time for the block B3, and the lighting time per cycle C1 of the light emitting elements LDR in the block B2 to be 71.2% of the lighting time for the block B3.

In FIG. 6, the lighting time per cycle C1 of the light emitting element LDR in the block B3 is represented as time TSR by a broken line. As described above, in FIG. 6, the times TR1 and TR2 are shorter than the time TSR (TR1<TSR, TR2<TSR).

In addition, since the light emitting element LDR in the block B1 is located farther from the center line XCT than the light emitting elements LDR in the blocks B2, B3, and B4, the controller CNT controls the lighting time per cycle C1 of the light emitting element LDR in the block B1 to be the shortest, among the light emitting elements LDR of the light source unit LU2. In other words, the controller CNT controls the lighting time per cycle C1 of the light emitting element LDR to be shorter as the distance from the center line XCT increases.

The light emitting elements LDB will be focused. For example, the controller CNT controls each lighting time per cycle C1, based on positions of the plurality of light emitting elements LDB in the first direction X.

For example, the blocks B3 and B4 will be focused. The light emitting element LDB in the block B3 and the light emitting element LDB in the block B4 are adjacent to each other in the first direction X, as shown in FIG. 5. The light emitting element LDB in the block B4 is located farther from the center line XCT than the light emitting element LDB in the block B3.

In this case, the controller CNT controls the lighting time per cycle C1 of the light emitting elements LDB in the block B4 to be shorter than that of the light emitting element LDB in the block B3.

In FIG. 7, the lighting times per cycle C1 of the light emitting elements LDB of blocks B3 and B4 are represented as time TB3 and time TB4. As described above, in FIG. 7, the time TB4 is shorter than the time TB3 (TB4<TB3).

Among the light emitting elements LDB, the light emitting element LDB in the block B2 is the closest to the center line XCT. The lighting time per cycle C1 of the light emitting element LDB in the block B2 is assumed to be 100%. Incidentally, the lighting time per cycle C1 of the light emitting element LDB in the block B4 is equal to, for example, the lighting time per cycle C1 of the light emitting element LDR in the block B3.

In this case, for example, the controller CNT controls the lighting time per cycle C1 of the light emitting element LDB in the block B3 to be 71.7% of the lighting time for the block B2, and the lighting time per cycle C1 of the light emitting elements LDB in the block B4 to be 51.7% of the lighting time for the block B2.

In FIG. 7, the lighting time per cycle C1 of the light emitting element LDR in the block B2 is represented as time TSB by a broken line. As described above, in FIG. 7, the times TB3 and TB4 are shorter than the time TSB (TB3<TSB, TB4<TSB).

Furthermore, when the light emitting elements LDR and LDB are compared, the difference between the lighting time per cycle C1 of the light emitting elements LDB in the block B3 and that of the light emitting element LDB in the block B4 is greater than, for example, the difference between the lighting time per cycle C1 of the light emitting element LDR in the block B1 and that of the light emitting element LDR in the block B2.

In addition, since the light emitting element LDB in the block B4 is located farther from the center line XCT than the light emitting elements LDB in the blocks B1, B2, and B3, the controller CNT controls the lighting time per cycle C1 of the light emitting element LDB in the block B4 to be the shortest, among the light emitting elements LDB of the light source unit LU2. In other words, the controller CNT controls the lighting time per cycle C1 of the light emitting element LDB to be shorter as the distance from the center line XCT increases.

The light emitting element LDG will be focused. The controller CNT controls the lighting time of the light emitting element LDG based on, for example, the lighting times of adjacent light emitting elements LDR and LDB. More specifically, the controller CNT controls the lighting time of the light emitting element LDG so as to prevent non-uniformity in luminance from occurring.

It is assumed that the lighting time (time TSB) per cycle C1 of the light emitting element LDB in the block B2 is 100%. In this case, for example, the controller CNT controls the lighting time per cycle C1 of the light emitting element LDG in the block B1 to 85.0% of the lighting time for the block B2, the lighting time per cycle C1 of the light emitting element LDG in the block B2 to 77.9% of the lighting time for the block B2, the lighting time per one cycle C1 of the light emitting element LDG in the block B3 to 90.9% of the lighting time for the block B2, and the lighting time per one cycle C1 of the light emitting element LDG in the block B4 to 81.0% of the lighting time for the block B2.

Incidentally, the lighting times (pulse widths) of the light emitting elements LDG, LDG, and LDG may be appropriately changed depending on the number of light emitting elements, the length in the first direction X of the side surface SF2, and the like.

Furthermore, when the current supplied to the light emitting elements LDR is focused, the controller CNT controls the current having the same current value to be supplied to the light emitting elements LDR in the blocks B1 to B4. In the example shown in FIG. 6, the current values supplied to the light emitting elements LDR in the blocks B1 and B2 are equal to each other.

Similarly, when the current supplied to the light emitting elements LDG and LDB is focused, the controller CNT controls the current having the same current value to be supplied to the light emitting elements LDG and LDB in the blocks B1 to B4. In the example shown in FIG. 7, the current values supplied to the light emitting elements LDB in the blocks B3 and B4 are equal to each other.

Incidentally, the current values of the current supplied to the light emitting elements LDR may be equal to at least one of the current values supplied to the light emitting elements LDG and LDB, or may be equal to or different from both of the current values of the current supplied to the light emitting elements LDG and LDB.

The current values are determined based on, for example, Wall-Plug Efficiency (WPE). The Wall-Plug Efficiency refers to the ratio of the light output to the total power input to the light emitting elements.

More specifically, the current values are current values which urge the Wall-Plug Efficiencies of the respective light emitting elements LDR, LDG, and LDB to be the highest. The light emitting elements LDR, LDG, and LDB can be thereby used under the most efficient conditions. The supplied current values are stored in advance in, for example, a memory device (not shown).

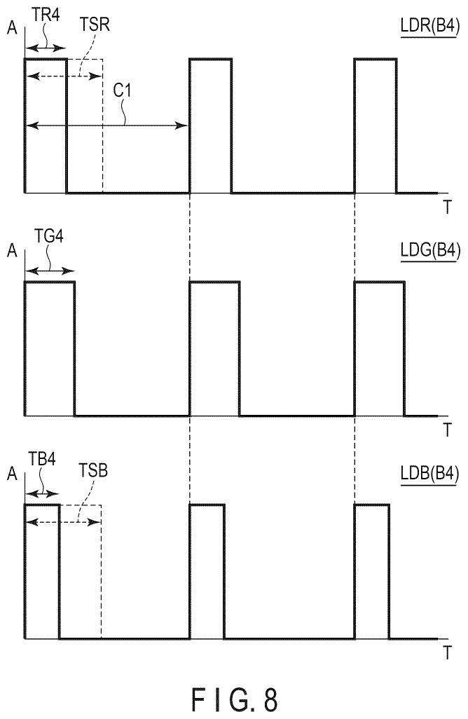

FIG. 8 is a timing chart showing an example of controlling the light emitting elements LDR, LDG, and LDB by the controller CNT. FIG. 8 shows the timing chart for the light emitting elements LDR, LDG, and LDB in the block B4. In FIG. 8, the lighting time per one cycle C1 of the light emitting element LDG is represented as time TG4.

As shown in FIG. 8, the timing of the start of lighting of the light emitting elements LDR, LDG, and LDB during one cycle C1 is, for example, simultaneous. In the example shown in FIG. 8, time TR4, time TG4, and time TB4 are different from one another.

The controller CNT controls the lighting times per one cycle C1 of the light emitting elements LDG, LDG, and LDB in synchronization with, for example, the control signal supplied to the display panel PNL. When the current values are focused, the current values of the current supplied to the light emitting elements LDG, LDG, and LDB are equal to one another.

Incidentally, in the blocks B1, B2, and B3, the lighting times per cycle C1 of the light emitting elements LDR, LDG, and LDB are appropriately controlled in the same manner as that in the block B4.

The light emitted from the plurality of light emitting elements LDR, LDG, and LDB propagates through the interior of the light guide LG2 while being diffused in the first area A1, causing the colors to be mixed, and is then emitted from the second area A2, as described with reference to FIG. 3.

For example, in the second area A2, non-uniformity in luminance may be visually recognized depending on the position in the first direction X. In particular, when the light emitting elements are laser light sources (laser diodes), the high directionality of the emitted light makes it difficult for the colors to be mixed sufficiently in the light guide LG2, and the non-uniformity in luminance may be visually recognized. In FIG. 5, parts of the area which are separated from the center line XCT, of the second area A2, are shown as the third area A3 and the fourth area A4.

When the third area A3 is focused, the distance from the light emitting elements LDB to the third area A3 is shorter than the distance from the light emitting element LDR to the third area A3, in the block B1. For this reason, when the outputs of the light emitting elements LDG, LDG, and LDB are the same, the luminance of red is more likely to be higher than that of blue in the third area A3. As a result, red can be visually recognized more easily in the third area A3.

In contrast, when the fourth area A4 is focused, the distance from the light emitting elements LDB to the fourth area A4 is shorter than the distance from the light emitting element LDR to the fourth area A4, in the block B4. For this reason, when the outputs of the light emitting elements LDG, LDG, and LDB are the same, the luminance of blue is more likely to be higher than that of blue in the fourth area A4. For this reason, blue can be visually recognized more easily in the fourth area A4.

In the present embodiment, the controller CNT controls the lighting time per cycle C1, based on positions of the light emitting elements LDR, LDG, and LDB in the first direction X. More specifically, the controller CNT controls the lighting time per cycle C1 of one light emitting element LDR located farther from the center of the side surface SF3, of two light emitting elements LDR adjacent to each other in the first direction X, to be shorter than the lighting time per cycle C1 of the other light emitting element LDR.

For example, the controller CNT controls the lighting time per one cycle C1 of the light emitting element LDR in the block B1 to be shorter than the lighting time per one cycle C1 in the light emitting element LDR of the block B2. Accordingly, occurrence of the non-uniformity in luminance in the third area A3 can be suppressed by suppressing the luminance of the red light emitted from the light emitting element LDR.

Similarly, the controller CNT controls the lighting time per cycle C1 of one light emitting element LDB located farther from the center of the side surface SF3, of two light emitting elements LDB adjacent to each other in the first direction X, to be shorter than the lighting time per cycle C1 of the other light emitting element LDB.

For example, the controller CNT controls the lighting time per cycle C1 of the light emitting elements LDB in the block B4 to be shorter than that of the light emitting element LDB in the block B3. Accordingly, occurrence of the non-uniformity in luminance in the fourth area A4 can be suppressed by suppressing the luminance of the blue light emitted from the light emitting element LDR.

Furthermore, in the present embodiment, the controller CNT controls the lighting time per cycle C1 of the light emitting element LDG based on the lighting times per cycle C1 of adjacent light emitting elements LDR and LDB, thereby further suppressing the occurrence of non-uniformity in luminance.

Thus, in the present embodiment, occurrence of the non-uniformity in luminance in the second area A2 can be suppressed and the uniformity of the emitted light can be improved by individually controlling the lighting times per cycle C1 of the light emitting elements LDR, LDG, and LDB by the controller CNT.

As a result, the display quality in the display device DSP can be further improved. In particular, even when the light emitting elements LDR, LDG, and LDB are laser light sources with high linear propagation of light, the uniformity of the emitted light can be improved.

In the present embodiment, the controller CNT controls the lighting time per cycle C1 of the light emitting element LDR in the block B1 among the light emitting elements LDR of the light source unit LU2 to be the shortest. In addition, the controller CNT controls the lighting time per cycle C1 of the light emitting element LDB in the block B4 among the light emitting elements LDB of the light source unit LU2 to be the shortest.

By thus adjusting the lighting time per cycle C1 of the light emitting element LDR in the block B1 and the light emitting element LDB in the block B4, which are located at both ends of the side surface SF3, the uniformity of the emitted light can be improved in the area where the non-uniformity in luminance is likely to occur.

In addition, adjusting the output of the light emitting elements is one of measures against the above-described non-uniformity in luminance. For example, if the current value of the current supplied to increase the output of the light emitting element lacking in color is set to be high, the Wall-Plug Efficiency may be lowered. One of the reasons is that the light emitting elements generate heat as the current value rises.

In the present embodiment, the controller CNT controls the current having the same current value to be supplied to the light emitting elements LDR, LDG, and LDB in the blocks B1 to B4. More specifically, the current values are current values which urge the Wall-Plug Efficiencies of the respective light emitting elements LDR, LDG, and LDB to be the highest.

As a result, in the present embodiment, the light emitting elements LDR, LDG, and LDB can be made to emit light under the most efficient conditions. In other words, in the present embodiment, the light emitting elements LDR, LDG, and LDB can be made to emit light under the most efficient conditions and the non-uniformity in luminance can be suppressed.

In FIG. 5 and FIG. 6, an example of control by the controller CNT using the light source unit LU2 has been described. In the light source unit LU1 as well, however, the controller CNT controls the lighting times per cycle C1 of light emitting elements LDR, LDG, and LDB in the same manner as that in the light source unit LU2.

In other words, the uniformity of the emitted light in the first area A1 can be improved by individually controlling the lighting times per cycle C1 of the light emitting elements LDR, LDG, and LDB of the light source unit LU1 by the controller CNT.

According to the display device DSP configured as described above and the method of controlling the display device DSP, the display quality can be improved. In addition, various desirable effects can be obtained from the present embodiment.

Incidentally, in the present embodiment, the example that the light emitting elements LDR, LDG, and LDB are the laser light sources has been disclosed. However, the light emitting elements LDR, LDG, and LDB may also be LED.

All of the display devices that can be implemented by a person of ordinary skill in the art through arbitrary design changes to the display device described above as the embodiment of the present invention come within the scope of the present invention as long as they are in keeping with the spirit of the present invention. Various modified examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or adding or omitting a step or changing the condition of a step, all of the modifications fall within the scope of the present invention as long as they are in keeping with the spirit of the invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device comprising:
a display panel having a display area;
a light guide having a side surface, and a main surface facing the display panel;
a light source unit facing the side surface and emitting light toward the light guide; and
a controller controlling the light source unit, wherein
the light source unit includes a plurality of first light emitting elements arranged along the side surface to emit light of the same color, and
when a period from the time when the light source unit is turned on until the time when the light source unit is turned on again is referred to as one cycle, the controller controls a lighting time per one cycle of one first light emitting element which is located farther from a center of the side surface, of two adjacent first light emitting elements, to be shorter than a lighting time per one cycle of the other first light emitting element.

2. The display device of claim 1, wherein
the plurality of first light emitting elements are laser diodes.

3. The display device of claim 1, wherein
the controller controls supplying currents having the same current values to the two adjacent first light emitting elements.

4. The display device of claim 1, wherein
the light source unit further includes a plurality of second light emitting elements emitting light of the same color,
the color emitted from the second light emitting elements is different from the color emitted from the first light emitting elements, and
the controller controls a lighting time per one cycle of one second light emitting element which is located farther from a center of the side surface, of two adjacent second light emitting elements, to be shorter than a lighting time per one cycle of the other second light emitting element.

5. The display device of claim 4, wherein
the controller controls supplying currents having the same current values to the two adjacent second light emitting elements.

6. The display device of claim 4, wherein
the light source unit further includes a plurality of third light emitting elements emitting light of the same color,
the color emitted from the third light emitting elements is different from the colors emitted from the first light emitting elements and the second light emitting elements,
the first light emitting elements, the third light emitting elements, and the second light emitting elements are repeatedly arranged in this along the side surface, and
the first light emitting elements and the second light emitting elements are located on both ends of the side surface of the light source unit.

7. The display device of claim 6, wherein
the side surface has a first end portion and a second end portion located on a side opposite to the first end portion, and
the controller controls the lighting time per one cycle of the first light emitting element facing the first end portion, of the plurality of first light emitting elements, to be the shortest, and controls the lighting time per one cycle of the second light emitting element facing the second end portion, of the plurality of second light emitting elements, to be the shortest.

8. The display device of claim 6, wherein
the controller controls supplying currents having the same current values to the plurality of first light emitting elements, the plurality of second light emitting elements, and the plurality of third light emitting elements.

9. A method of controlling a display device comprising a display panel having a display area, a light guide having a side surface, and a main surface facing the display panel, and a light source unit facing the side surface and emitting light toward the light guide, the method comprising:
when a period from the time when the light source unit is turned on until the time when the light source unit is turned on again is referred to as one cycle, making a lighting time per one cycle of one light emitting element which is located farther from a center of the side surface, of two adjacent light emitting elements provided in the light source unit and emitting light of the same color, shorter than a lighting time per one cycle of the other light emitting element.

10. The control method of claim 9, further comprising:
supplying currents having the same current value to the two adjacent light emitting elements.

11. The control method of claim 9, further comprising:
controlling pulse widths of light source control signals supplied to the two adjacent light emitting elements.

12. The control method of claim 9, further comprising:
controlling the lighting time per one cycle of the light emitting element facing the end portion of the side surface, of the plurality of light emitting elements, to be the shortest.
